(19) United States
(12) Patent Application Publication
(10) Pub. No.: US 2009/0057959 A1
(43) Pub. Date: Mar. 5, 2009

(54) Method for Embellishing Customized Label on Handle via Laser-Engraving

(76) Inventor: Leo Jaw, Taichung Hsien (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/845,442

(22) Filed: Aug. 27, 2007

(51) Int. Cl. B29C 35/08

(52) U.S. Cl. 264/400

(57) ABSTRACT

A method for embellishing customized label on a handle via laser-engraving comprises: first step: preparing a body of the handle injected from a mold, with the body provided to be colored; second step: injecting a surface layer surrounding the body, with the surface layer having different color from the body; third step: laser-engraving with a label on the surface layer and removing parts of the surface layer relative to the shape of the label, with parts of the colored body being exposed thereafter, with getting a finished handle.

### BACKGROUND OF THE INVENTION

1. Field of the Invention

The present invention relates to a method for embellishing customized labels on a handle and, more particularly, to a method for embellishing customized labels on a handle by laser-engraving.

2. Description of the Related Art

FIGS. 12 to 15 show a conventional method for embellishing a handle 1. The conventional method includes the following steps: first step is preparing a body 2 of the handle 1 injected from a mold, with the body 2 having a brand label 3 thereon simultaneously; second step is attaching a rubber coated fabric 4 over the brand label 3, then removing parts of the rubber coated fabric 4 out of the brand label 3; third step is covering the brand label 3 with paint 5 (seen as FIGS. 12 and 13).

FIG. 14 shows a finished handle 1, and the method for embellishing a handle should be worked done by hands for doing the attachment of the rubber coated fabric 4 over the brand label 3 and the cover of the brand label 3 with paint 5. Therefore, it is restricted to increase productivity. And if the process of attaching the rubber coated fabric 4 is imperfect, it's easy to cause paint 5 to cover parts of the body 2 except for the brand label 3 and to control the yield rate would be difficult.

Furthermore, for embellishing various customized labels on handles, it should make different molds respectively corresponding to foregoing customized labels on handles. Thus, it increases costs for production.

Furthermore, paint 5 that covering the brand label 3 is easy to come off during use for long (seen as FIG. 15). Paint 5 is likely to fade way specifically because of change of temperature or surroundings so that degrading the produce value.

The present invention has arisen to mitigate and/or obviate the afore-described disadvantages.

### SUMMARY OF THE INVENTION

The present invention solves this need and other problem in the field of methods for embellishing various customized labels on a handle via laser engraving quickly and dealing with low-volume order easily. Furthermore, provide another method for embellishing a handle by laser engraving, with parts of the colored body being exposed thereafter. The shape and depth of the laser-engraved label would be changed as requirement of customers easily and quickly.

The present invention will become clearer in light of the following detailed description of illustrative embodiment of this invention described in connection with the drawings.

### BRIEF DESCRIPTION OF THE DRAWINGS

FIG. 1 is a flow chart showing a method for embellishing a handle in accordance with a first embodiment of the present invention.

FIG. 2 shows a perspective view of a body of the handle injected from a mold in accordance with the first embodiment of the present invention.

FIG. 3 shows a cross-sectional view taken along 3-3 in FIG. 2.

FIG. 4 shows a perspective view of the body of the handle in accordance with the first embodiment of the present invention, illustrating the embellishment of surface of the handle by using a laser engraving machine.

FIG. 5 shows a perspective view of a finished handle in accordance with the first embodiment of the present invention.

FIG. 6 is a flow chart showing a method for embellishing a handle in accordance with a second embodiment of the present invention

FIG. 7 shows a perspective view of the body of the handle in accordance with the second embodiment of the present invention, illustrating a surface layer injected surrounding the body of the handle.

FIG. 8 shows a cross-sectional view taken along 8-8 in FIG. 7.

FIG. 9 shows a perspective view of the body of the handle in accordance with the second embodiment of the present invention, illustrating the embellishment of the surface layer of the handle by using a laser engraving machine.

FIG. 10 shows a perspective view of a finished handle in accordance with the second embodiment of the present invention.

FIG. 11 shows a cross-sectional view taken along 11-11 in FIG. 10.

FIG. 12 shows a perspective view of a conventional handle attached a rubber coated fabric thereon.

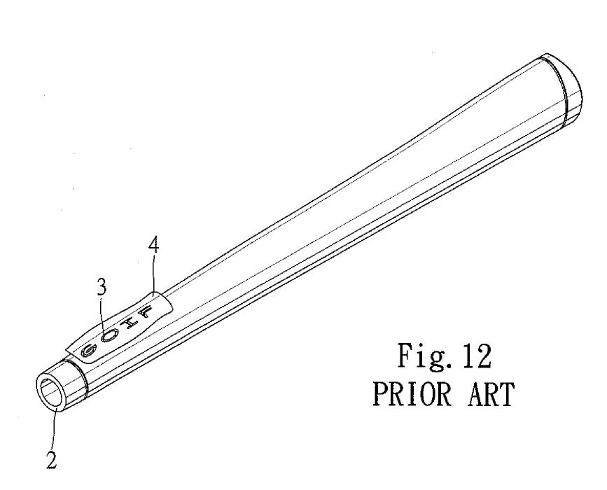

FIG. 13 shows a perspective view of the conventional handle covered with paint.

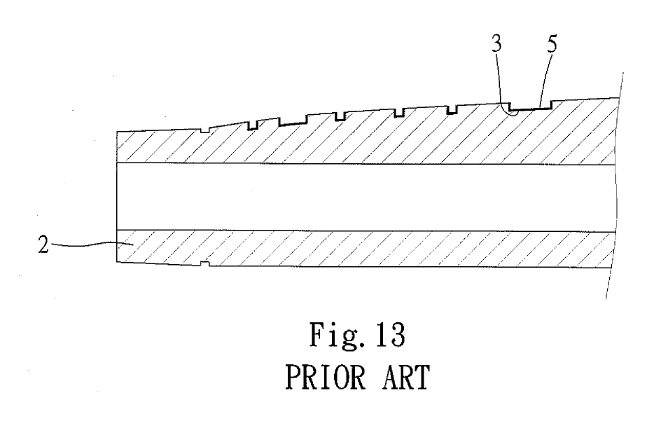

FIG. 14 shows a perspective view of a conventional finished handle.

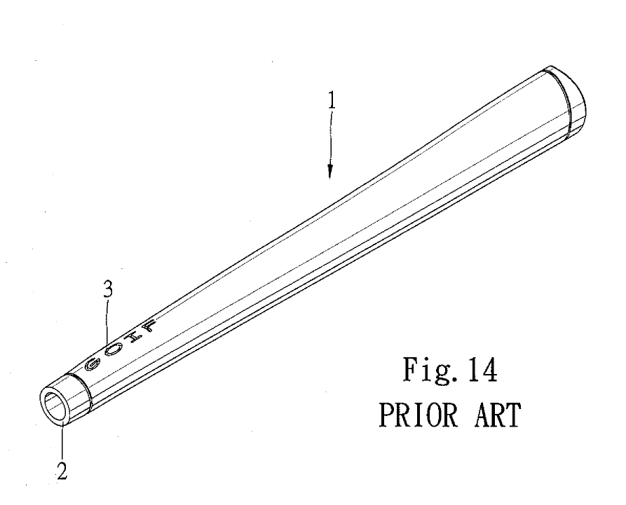

FIG. 15 shows a perspective view of the conventional handle with paint coming off.

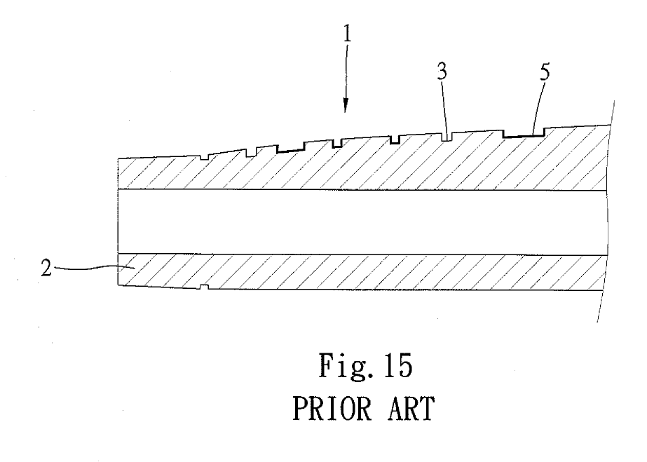

### DETAILED DESCRIPTION OF THE PREFERRED EMBODIMENT

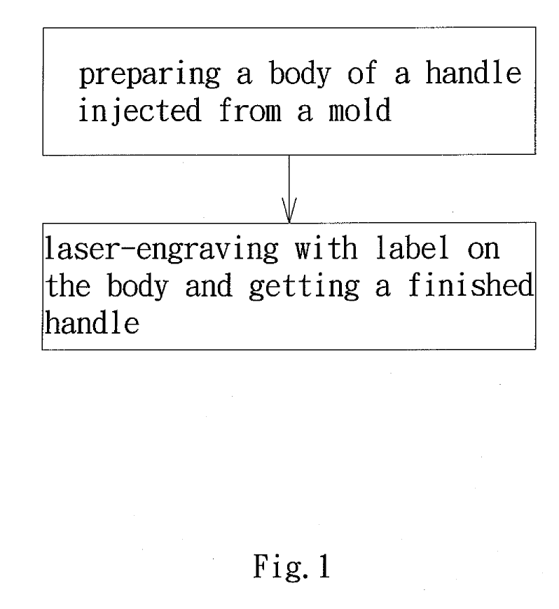

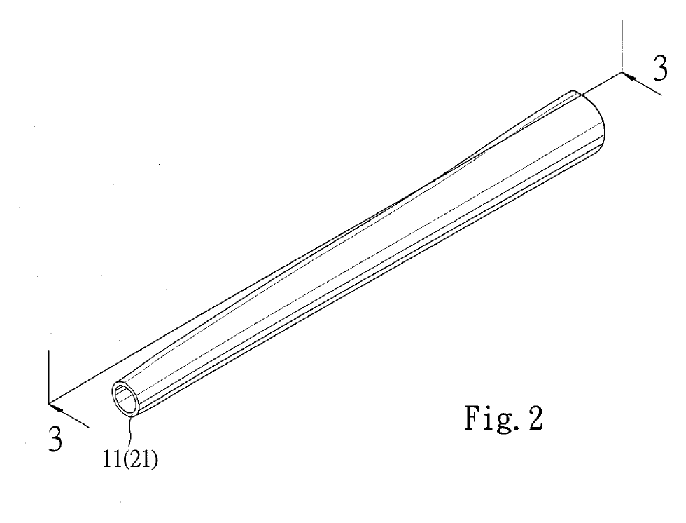

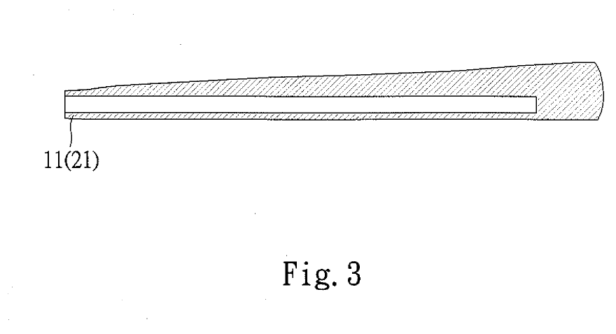

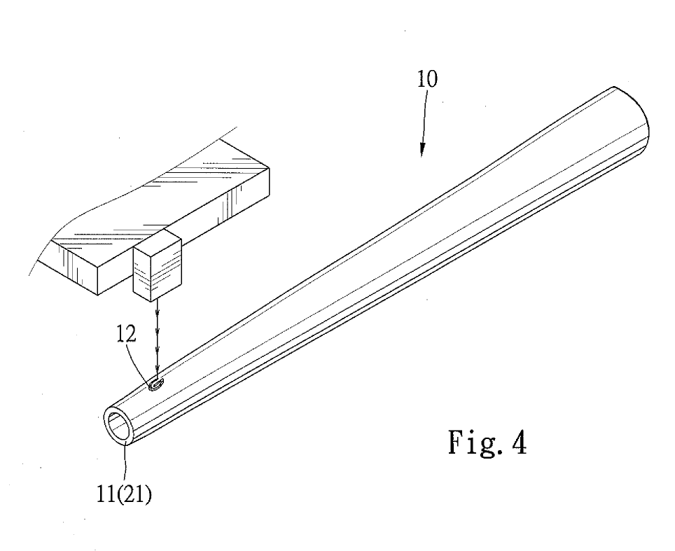

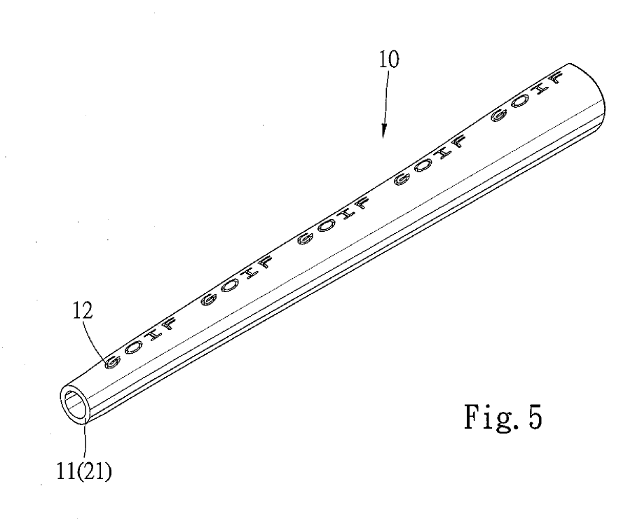

Referring to FIG. 1, a method for embellishing a handle 10 in accordance with a first embodiment of the present invention includes the following steps: first step is injecting a body 11 from a mold (seen as FIGS. 2 and 3); second step is laser-engraving the body 11 with desired label 12 thereon (seen as FIG. 4) and getting a finished handle 10 (seen as FIG. 5).

The shape and depth of label 12 could be changed as requirement of customers quickly and easily by laser engraving and it is unnecessarily to make a new mold for desired labels with various shapes or depth. Meanwhile, it leads to a decrease in the period of time for production and in the costs.

Because the depth of the label 12 is deep enough so that it would not come off as easily as the painted brand label on a conventional handle by frequent use.

The present invention provides a kind of laser with high power-density for scanning surface of the handle 10 to heat the body 11 to thousand degrees even to ten thousand degrees, thus the material of the body 11 would fuse or vapor. Then, blow the fused or vapored parts of the body 11 by high-pressured air and embellish the body 11.

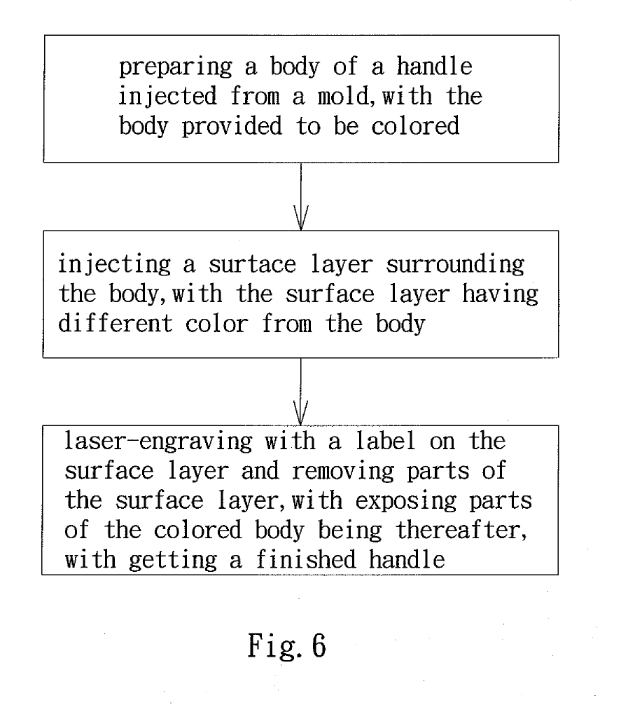

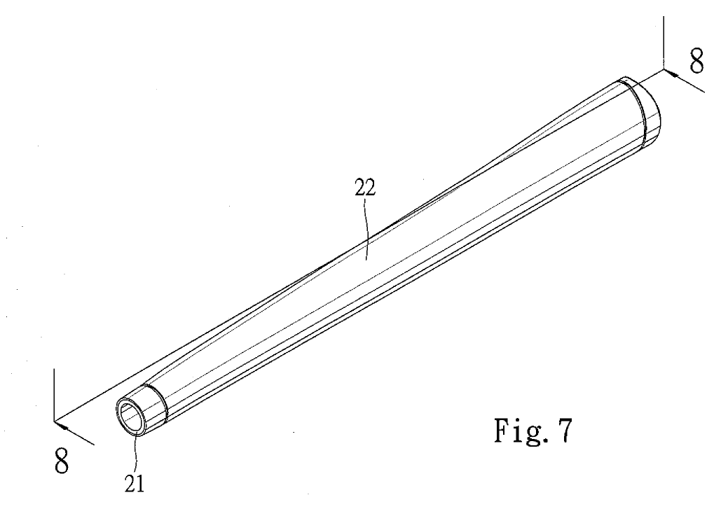

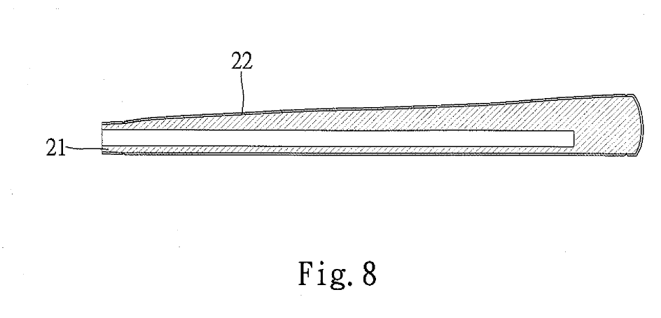

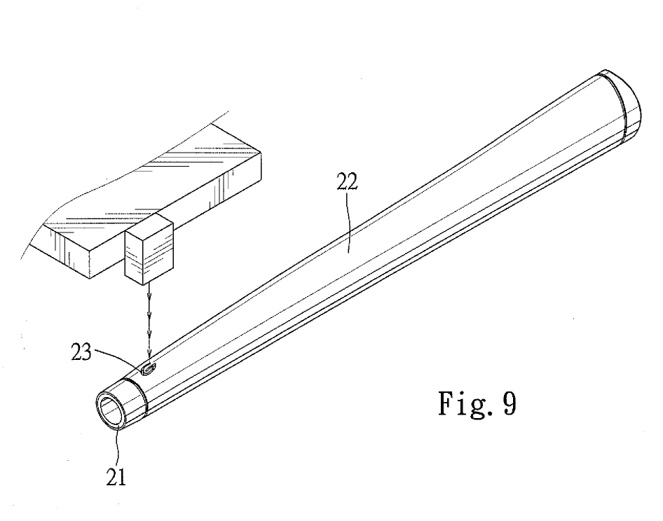

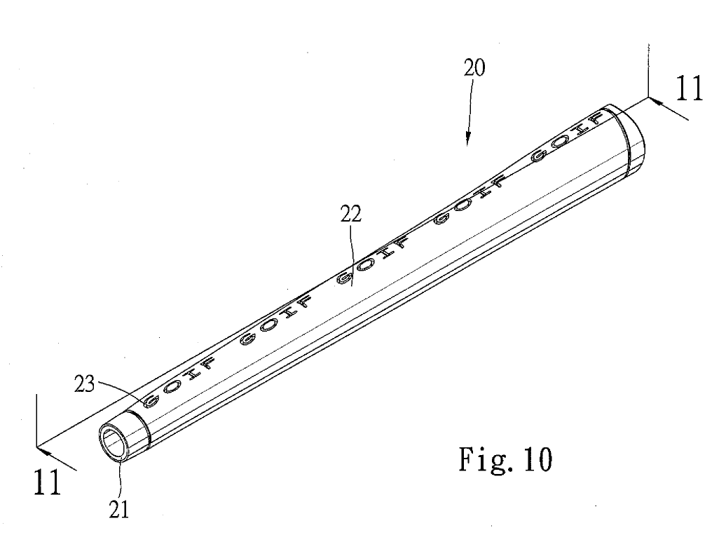

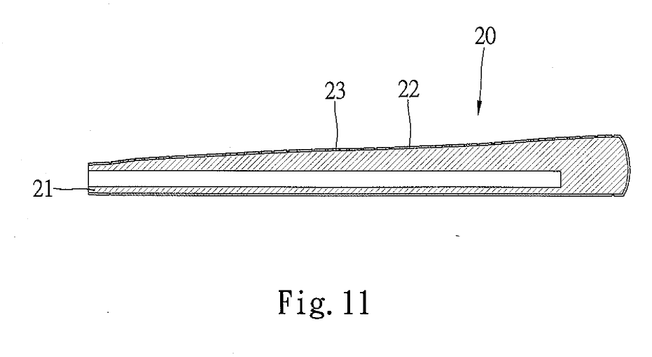

Referring to FIG. 6, a method for embellishing a handle 20 in accordance with a second embodiment of the present invention includes the following steps: first step is preparing a body 21 injected from a mold, with the body 21 provided to be colored for being a ground of label; second step is disposing the body 21 in another mold and injecting a surface layer 22 surrounding the body 21, with the surface layer 22 having different color to that of the body 21 (seen as FIGS. 7 and 8); third step is laser-engraving with a desired label 23 on the surface layer 22, with the removal of parts of the surface layer 22, with parts of the colored body 21 being exposed thereafter (seen as FIG. 9), and getting a finished handle 20 (seen as FIGS. 10 and 11).

The shape and depth of label 23 could be changed as requirement of customers quickly and easily by laser engraving and it is unnecessarily to make a new mold for desired labels with various shapes or depth. Meanwhile, it leads to a decrease in the period of time for production and in the costs.

Parts of the surface layer 22 corresponding to shape of the label 23 is removed by laser engraving and parts of the colored body 21 would be exposed so that the label 23 would be sharp and it is unnecessarily to attach rubber coated fabric on the label and cover the label with paint by hand. It would increase productivity and save costs.

Because the colored ground for the label 23 is provided from the colored body 21, the problem of color fading during use for long would be eliminated.

The present invention provides a kind of laser with high power-density for scanning surface of the handle 20 to heat the surface layer 22 to thousand degrees even to ten thousand degrees, thus the material of the surface layer 22 would fuse or vapor. Then, to blow the fused or vapored parts of the surface layer 22 by high-pressured air and to embellish handle 20 with the desired label 23. The present invention preferably uses CO2 laser machine or Nd-Yag Laser machine.

The method for embellishing on the handle via laser engraving according to the present invention would promote environmental protection and the method could replace the conventional printing or labels provided on the handle. Moreover, the laser-engraving embellishment would not come off from the handle during use for a long time.

The method for embellishing on the handle via laser engraving according to the present invention is humanized processed-technique and it could reduce the cost to make various molds corresponding to various embellishments on the handles. Formerly, the brand labels usually are printed or stuck on the surface of goods; therefore, if changing the brand label, it is necessary to make a new mold afresh. However, if using the method for embellishing the surface on the handle via laser engraving machine, while changing the brand label, the customers just need to change the pattern for laser engraving. In additional, embellishing the surface on the handle by laser engraving could make the impression of goods better.

Thus since the invention disclosed herein may be embodied in other specific forms with out departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come with the meaning and range of equivalency of the claims are intended to be embraced therein.

What is claimed is:

1. A method for embellishing customized label on a handle via laser-engraving comprising:
first step: preparing a body of the handle injected from a mold, with the body provided to be colored;
second step: injecting a surface layer surrounding the body, with the surface layer having different color from the body;
third step: laser-engraving with a label on the surface layer and removing parts of the surface layer relative to the shape of the label, with parts of the colored body being exposed thereafter, with getting a finished handle.

2. A method for embellishing customized label on a handle via laser-engraving comprising:
first step: preparing a body of the handle injected from a mold;
second step: laser-engraving with a label on the body and getting a finished handle.

3. A method for embellishing customized label on a handle via laser-engraving as claimed in claim 1, wherein the label is customized and the depth and shape of the label is adjustable via laser engraving.

4. A method for embellishing customized label on a handle via laser-engraving as claimed in claim 2, wherein the label is customized and the depth and shape of the label is adjustable via laser engraving.
